(19) United States
(12) Patent Application Publication
(10) Pub. No.: US 2026/0046977 A1
(43) Pub. Date: Feb. 12, 2026

(54) SYNCHRONIZATION SIGNAL BLOCK (SSB) TRANSMISSION CONSTRAINT FOR INTRA-SSB BURST PHYSICAL BROADCAST CHANNEL COMBINING

(71) Applicant: QUALCOMM Incorporated, San Diego, CA (US)

(72) Inventors: Jae Ho RYU, San Diego, CA (US); Yongle WU, San Diego, CA (US); Changhwan PARK, San Diego, CA (US); Xiao Feng WANG, San Diego, CA (US)

(21) Appl. No.: 19/186,247

(22) Filed: Apr. 22, 2025

Related U.S. Application Data
(60) Provisional application No. 63/680,419, filed on Aug. 7, 2024.

(51) Int. Cl. H04W 76/40; H04B 7/06

(52) U.S. Cl. CPC H04W 76/40; H04B 7/06952

(57) ABSTRACT

Various aspects of the present disclosure generally relate to wireless communication. In some aspects, a user equipment (UE) may receive multiple synchronization signal blocks (SSBs) in an SSB burst, wherein the multiple SSBs in the SSB burst are subject to an SSB transmission constraint based at least in part on an SSB burst periodicity associated with the SSB burst. The UE may decode a physical broadcast channel (PBCH) using PBCH combining based at least in part on respective PBCH transmissions included in the multiple SSBs in the SSB burst. Numerous other aspects are described.

### CROSS-REFERENCE TO RELATED APPLICATION

This Patent Application claims priority to U.S. Provisional Patent Application No. 63/680,419, filed on Aug. 7, 2024, entitled “SYNCHRONIZATION SIGNAL BLOCK (SSB) TRANSMISSION CONSTRAINT FOR INTRA-SSB BURST PHYSICAL BROADCAST CHANNEL COMBINING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for a synchronization signal block (SSB) transmission constraint for intra-SSB burst physical broadcast channel (PBCH) combining.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be individually or collectively configured to receive multiple synchronization signal blocks (SSBs) in an SSB burst, wherein the multiple SSBs in the SSB burst are subject to an SSB transmission constraint based at least in part on an SSB burst periodicity associated with the SSB burst. The one or more processors may be individually or collectively configured to decode a physical broadcast channel (PBCH) using PBCH combining based at least in part on respective PBCH transmissions included in the multiple SSBs in the SSB burst.

Some aspects described herein relate to a network node for wireless communication. The network node may include one or more memories and one or more processors coupled to the one or more memories. The one or more processors may be individually or collectively configured to transmit multiple SSBs in an SSB burst in accordance with an SSB burst periodicity, wherein the multiple SSBs in the SSB burst are subject to an SSB transmission constraint based at least in part on the SSB burst periodicity. The one or more processors may be individually or collectively configured to receive, from a UE, a communication based at least in part on at least one of the multiple SSBs in the SSB burst.

Some aspects described herein relate to a method of wireless communication performed by a UE. The method may include receiving multiple SSBs in an SSB burst, wherein the multiple SSBs in the SSB burst are subject to an SSB transmission constraint based at least in part on an SSB burst periodicity associated with the SSB burst. The method may include decoding a PBCH using PBCH combining based at least in part on respective PBCH transmissions included in the multiple SSBs in the SSB burst.

Some aspects described herein relate to a method of wireless communication performed by a network node. The method may include transmitting multiple SSBs in an SSB burst in accordance with an SSB burst periodicity, wherein the multiple SSBs in the SSB burst are subject to an SSB transmission constraint based at least in part on the SSB burst periodicity. The method may include receiving, from a UE, a communication based at least in part on at least one of the multiple SSBs in the SSB burst.

Some aspects described herein relate to a non-transitory computer-readable medium that stores a set of instructions for wireless communication by a UE. The set of instructions, when executed by one or more processors of the UE, may cause the UE to receive multiple SSBs in an SSB burst, wherein the multiple SSBs in the SSB burst are subject to an SSB transmission constraint based at least in part on an SSB burst periodicity associated with the SSB burst. The set of instructions, when executed by one or more processors of the UE, may cause the UE to decode a PBCH using PBCH combining based at least in part on respective PBCH transmissions included in the multiple SSBs in the SSB burst.

Some aspects described herein relate to a non-transitory computer-readable medium that stores a set of instructions for wireless communication by a network node. The set of instructions, when executed by one or more processors of the network node, may cause the network node to transmit multiple SSBs in an SSB burst in accordance with an SSB burst periodicity, wherein the multiple SSBs in the SSB burst are subject to an SSB transmission constraint based at least in part on the SSB burst periodicity. The set of instructions, when executed by one or more processors of the network node, may cause the network node to receive, from a UE, a communication based at least in part on at least one of the multiple SSBs in the SSB burst.

Some aspects described herein relate to an apparatus for wireless communication. The apparatus may include means for receiving multiple SSBs in an SSB burst, wherein the multiple SSBs in the SSB burst are subject to an SSB transmission constraint based at least in part on an SSB burst periodicity associated with the SSB burst. The apparatus may include means for decoding a PBCH using PBCH combining based at least in part on respective PBCH transmissions included in the multiple SSBs in the SSB burst.

Some aspects described herein relate to an apparatus for wireless communication. The apparatus may include means for transmitting multiple SSBs in an SSB burst in accordance with an SSB burst periodicity, wherein the multiple SSBs in the SSB burst are subject to an SSB transmission constraint based at least in part on the SSB burst periodicity. The apparatus may include means for receiving, from a UE, a communication based at least in part on at least one of the multiple SSBs in the SSB burst.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating examples associated with a non-terrestrial network (NTN), in accordance with the present disclosure.

FIG. 5 is a diagram illustrating an example of a synchronization signal hierarchy, in accordance with the present disclosure.

FIG. 6 is a diagram illustrating an example associated with physical broadcast channel (PBCH) combining across synchronization signal block (SSB) bursts, in accordance with the present disclosure.

FIGS. 7A-7C are diagrams illustrating examples associated with an SSB transmission constraint for intra-SSB burst PBCH combining, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A non-terrestrial network (NTN) is a wireless communication network that includes one or more network nodes that operate above the Earth's surface, such as space or airborne network nodes. For example, a network node in an NTN may be a satellite, an unmanned aerial vehicle, or a high-altitude platform station (HAPS), among other examples. In some examples, an overhead associated with synchronization signal block (SSB) and system information block (SIB) type 1 (SIB1) transmissions may be significant in an NTN deployment. For example, an NTN may have a large number of downlink beams, and only a small portion of the downlink beams may be active simultaneously due to a power budget and/or radio frequency (RF) chain limitations (e.g., at a satellite network node). Even when specific downlink beams are not active for data transmission, the satellite network node may continuously transmit periodic SSB and SIB1 transmissions at a certain periodicity, which may result in a significant SSB/SIB1 transmission overhead. In 5G New Radio (NR), a periodicity for SSB/SIB1 transmissions (e.g., an SSB burst periodicity) may be 20 milliseconds (ms). In some examples, a periodicity for SSB/SIB1 transmissions (e.g., the SSB burst periodicity) may be increased in an NTN deployment (e.g., a power limited NTN deployment) to decrease the SSB/SIB1 transmission overhead. For example, the SSB burst periodicity in such an NTN deployments may be greater than 20 ms (e.g., 40 ms, 80 ms, or 160 ms, among other examples).

An SSB may include a primary synchronization signal (PSS), a secondary synchronization signal (SSS), and a physical broadcast channel (PBCH). The PBCH may include a master information block (MIB). An SSB burst may include one or more SSBs, and the SSB burst (e.g., the one or more SSBs in the SSB burst) may be transmitted by a network node in accordance with an SSB burst periodicity associated with the SSB burst. In some examples, the SSB burst periodicity may be 20 ms. In some examples, the SSB burst may include multiple SSBs that are transmitted on different beams. In such examples, the periodicity of a particular SSB (including the PBCH), in the SSB burst, transmitted on a given beam may be 20 ms (e.g., the SSB burst periodicity). Accordingly, the periodicity of a PBCH transmission (e.g., in an SSB) transmitted on a given beam that can be detected by a user equipment (UE) may be 20 ms (e.g., the SSB burst periodicity). In some examples, a PBCH transmission time interval (TTI) may be 80 ms, and an MIB payload included in the PBCH may be the same for all PBCH transmissions within the PBCH TTI. This may allow the UE to combine up to four PBCH transmissions within the PBCH TTI (e.g., detected across four SSB bursts within the PBCH TTI) to decode the PBCH and obtain the MIB payload of the PBCH. Such intra-TTI PBCH combining may significantly improve the PBCH decoding performance of the UE, as compared with decoding a single PBCH transmission.

In some examples, a wireless communication network may utilize an increased SSB burst periodicity (e.g., an SSB burst periodicity greater than 20 ms). For example, an NTN deployment may utilize an increased SSB burst periodicity (e.g., an SSB burst periodicity of 40 ms, 80 ms, or 160 ms, among other examples) to reduce an SSB transmission overhead. However, such an increased SSB burst periodicity may reduce the number of SSB bursts within a PBCH TTI, which may reduce the intra-TTI PBCH combining that can be performed by a UE, resulting in the PBCH decoding performance of the UE being degraded. In an example in which the SSB burst periodicity is larger than 40 ms (e.g., 80 ms or 160 ms, among other examples) and the PBCH TTI is 80 ms, the PBCH decoding performance of the UE may be degraded because the UE cannot rely on intra-TTI PBCH decoding. The degradation of the PBCH decoding performance of the UE may result in a downlink coverage bottleneck (e.g., in an NTN deployment), for example, due to an increase in failed attempts to decode the PBCH and obtain the MIB.

Various aspects relate generally to intra-SSB burst PBCH combining. “Intra-SSB burst combining” refers to combining multiple PBCH transmissions included in SSBs transmitted within the same SSB burst. Some aspects more specifically relate to an SSB transmission constraint for intra-SSB burst PBCH combining. In some aspects, a network node may transmit multiple SSBs in an SSB burst in accordance with an SSB burst periodicity. A UE may receive the multiple SSBs in the SSB burst. The multiple SSBs in the SSB burst may be subject to an SSB transmission constraint based at least in part on the SSB burst periodicity. For example, the SSB transmission constraint may be based at least in part on the SSB burst periodicity satisfying (e.g., being greater than) a periodicity threshold (e.g., 20 ms or 40 ms, among other examples). The UE may decode a PBCH using PBCH combining based at least in part on respective PBCH transmissions included in the multiple SSBs in the SSB burst. In some aspects, the SSB transmission constraint may enable, improve, facilitate, and/or simplify the PBCH combining (e.g., the intra-SSB burst PBCH combining) performed by the UE. In some examples, the multiple SSBs in the SSB burst, in accordance with the SSB transmission constraint, occupy adjacent SSB positions in the SSB burst. Additionally, or alternatively, in some examples, the multiple SSBs in the SSB burst, in accordance with the SSB transmission constraint, are associated with a same beam.

Particular aspects of the subject matter described in this disclosure can be implemented to realize one or more of the following potential advantages. In some examples, by transmitting the multiple SSBs in the SSB burst with the multiple SSBs subject to the SSB transmission constraint based at least in part on the SSB burst periodicity, the described techniques can be used to enable the UE to reliably perform intra-SSB burst PBCH combining to decode the PBCH. By decoding the PBCH using the intra-SSB burst PBCH combining, the PBCH decoding performance of the UE may be improved. In some examples, by subjecting the multiple SSBs in the SSB burst to the SSB transmission constraint based at least in part on the SSB burst periodicity satisfying the periodicity threshold, the described techniques can be used to enable the UE to reliably perform intra-SSB burst PBCH decoding in a scenario in which intra-TTI PBCH combining cannot be performed by the UE (or can be performed with a reduced number of PBCH transmission within the PBCH TTI) due to a large SSB burst periodicity. In this way, the UE may be able to recover from PBCH decoding performance degradation resulting from decoding the PBCH without (or with reduced) intra-TTI PBCH combining, and/or improve the overall PBCH decoding performance of the UE.

Multiple-access radio access technologies (RATs) have been adopted in various telecommunication standards to provide common protocols that enable wireless communication devices to communicate on a municipal, enterprise, national, regional, or global level. For example, 5G NR is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, NTN deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, RF sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

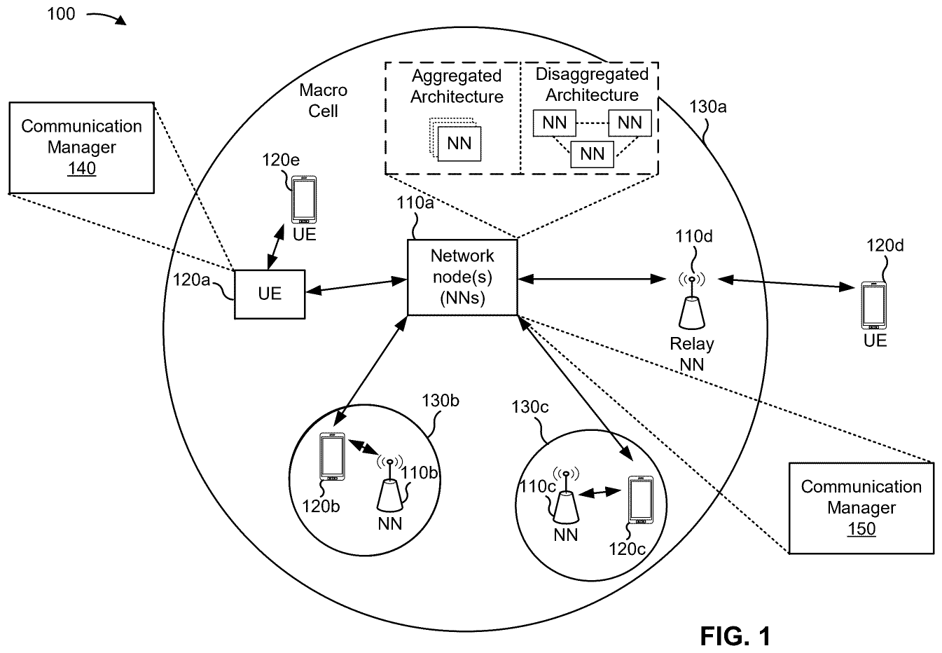

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network. ” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network transmission, or non-coherent joint transmission (NC-JT).

In some aspects, the UE 120 may include a communication manager 140. As described in more detail elsewhere herein, the communication manager 140 may receive multiple SSBs in an SSB burst, wherein the multiple SSBs in the SSB burst are subject to an SSB transmission constraint based at least in part on an SSB burst periodicity associated with the SSB burst; and decode a PBCH using PBCH combining based at least in part on respective PBCH transmissions included in the multiple SSBs in the SSB burst. Additionally, or alternatively, the communication manager 140 may perform one or more other operations described herein.

In some aspects, the network node 110 may include a communication manager 150. As described in more detail elsewhere herein, the communication manager 150 may transmit multiple SSBs in an SSB burst in accordance with an SSB burst periodicity, wherein the multiple SSBs in the SSB burst are subject to an SSB transmission constraint based at least in part on the SSB burst periodicity; and receive, from a UE, a communication based at least in part on at least one of the multiple SSBs in the SSB burst. Additionally, or alternatively, the communication manager 150 may perform one or more other operations described herein.

As indicated above, FIG. 1 is provided as an example. Other examples may differ from what is described with regard to FIG. 1.

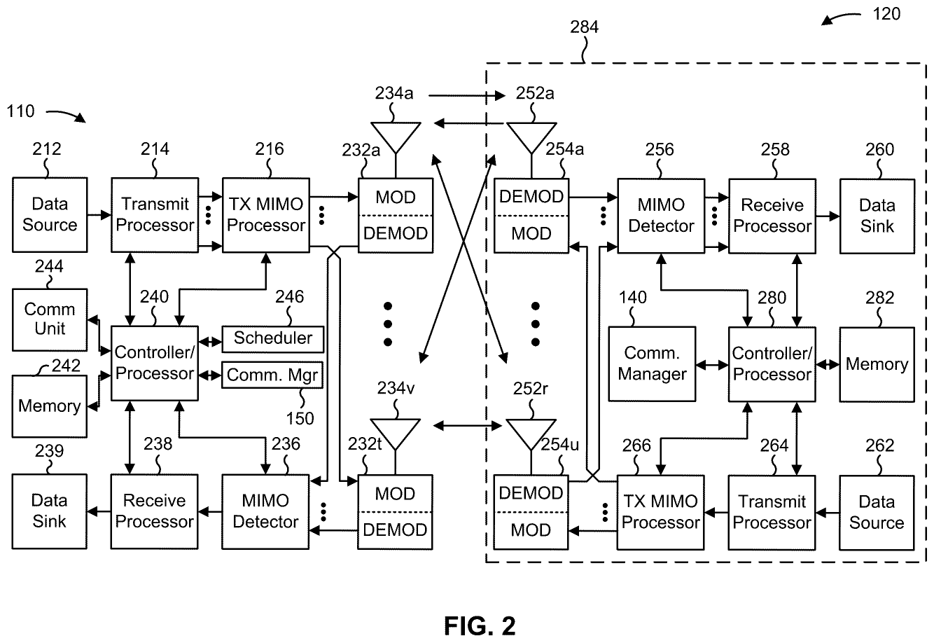

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a PSS or an SSS).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

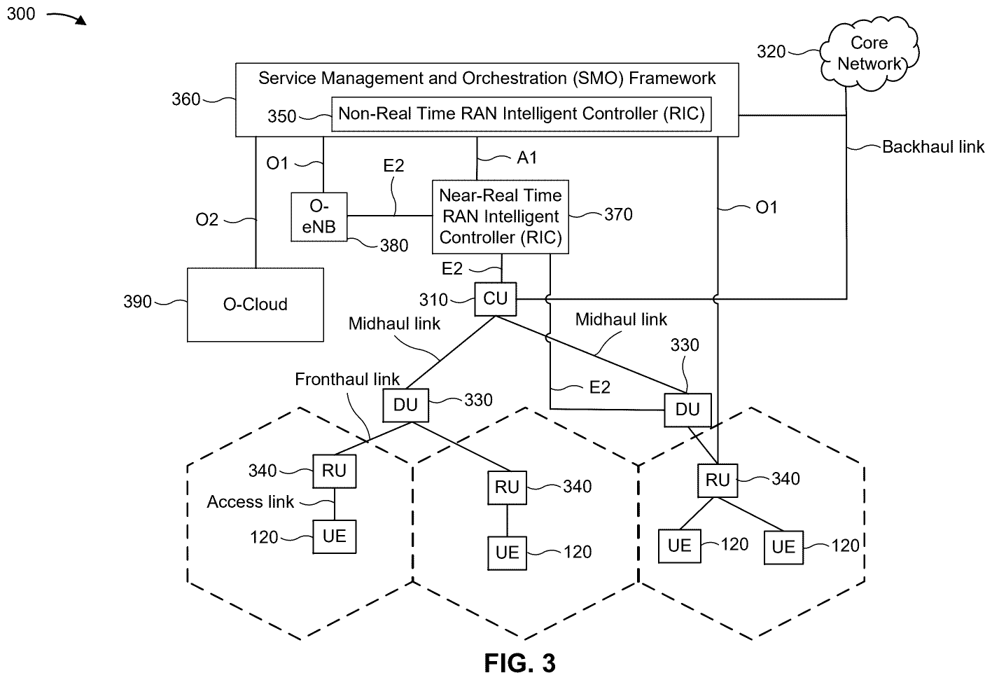

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

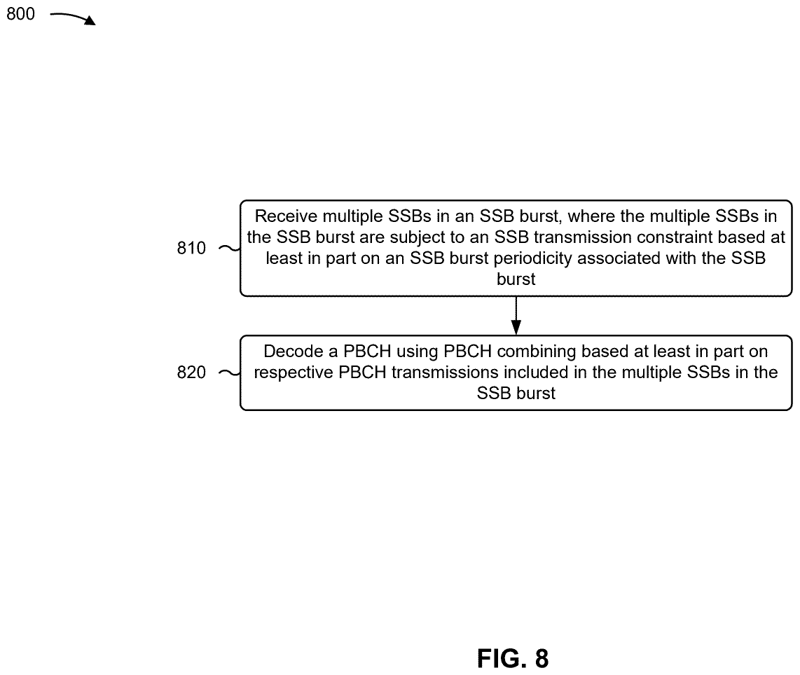

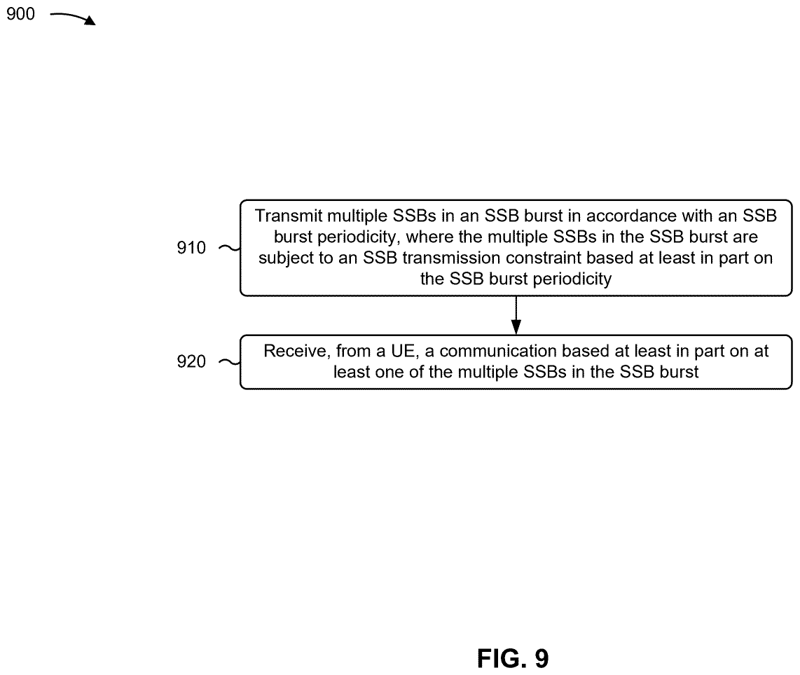

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with an SSB transmission constraint for intra-SSB burst PBCH combining, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for receiving multiple SSBs in an SSB burst, wherein the multiple SSBs in the SSB burst are subject to an SSB transmission constraint based at least in part on an SSB burst periodicity associated with the SSB burst; and/or means for decoding a PBCH using PBCH combining based at least in part on respective PBCH transmissions included in the multiple SSBs in the SSB burst. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting multiple SSBs in an SSB burst in accordance with an SSB burst periodicity, wherein the multiple SSBs in the SSB burst are subject to an SSB transmission constraint based at least in part on the SSB burst periodicity; and/or means for receiving, from a UE, a communication based at least in part on at least one of the multiple SSBs in the SSB burst. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

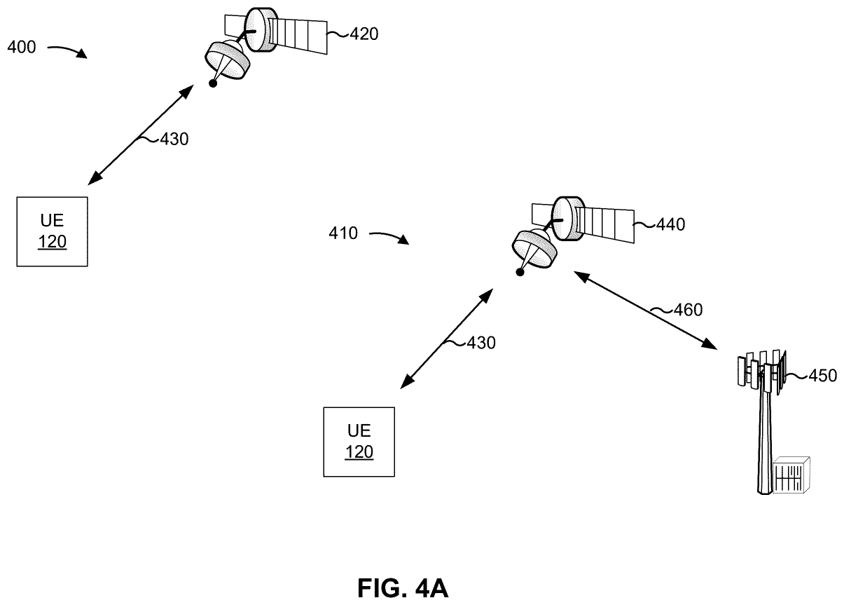

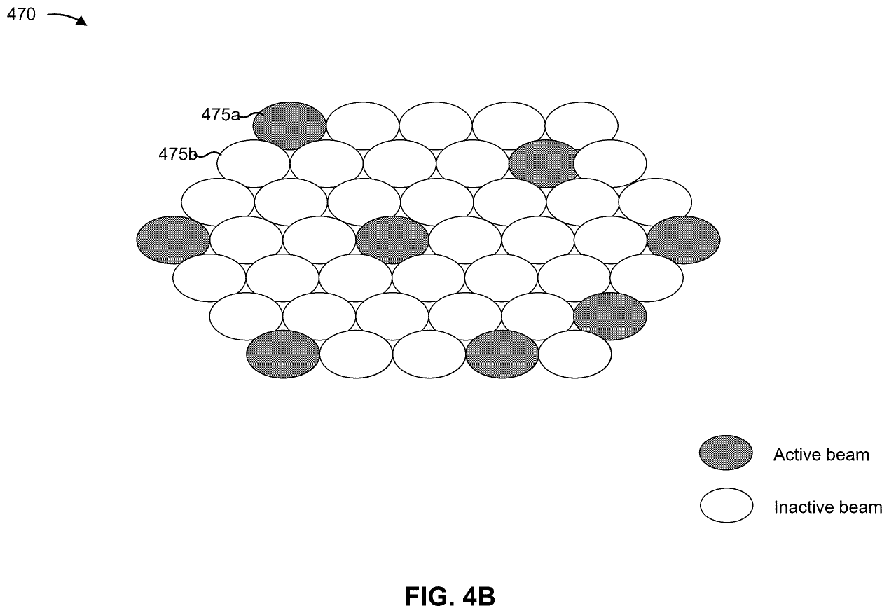

FIGS. 4A-4B are diagrams illustrating examples associated with an NTN, in accordance with the present invention. FIG. 4A shows an example 400 of a regenerative satellite deployment and an example 410 of a transparent satellite deployment in an NTN.

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as an NTN network node, a non-terrestrial network node, a non-terrestrial base station, a satellite network node, a satellite base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a GNSS capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120).

FIG. 4B shows an example 470 of a satellite footprint of a satellite network node (e.g., satellite 420 or satellite 440) in an NTN. The satellite footprint shows an overall geographical area that the satellite network node is capable of covering. As shown in FIG. 4B, the satellite footprint may include beam footprints 475 corresponding to different satellite beams of the satellite network node. For example, each beam footprint 475 may correspond to a respective satellite beam. In particular, each beam footprint 475 may show a coverage area associated with the corresponding satellite beam. In some examples, although the satellite footprint of the satellite network node may have a large total number of beam footprints 475 (corresponding to a large total number of satellite beams), only a small percentage (e.g., approximately 10%, in some NTN deployments) of the satellite beams may be simultaneously active. For example, in some NTN deployments, the total number of beam footprints is 1058 and the total number of simultaneously active beams is 106. In some examples, the number of simultaneously active downlink beams for the satellite network node may be limited to constraints on the maximum aggregated equivalent isotropic radiated power (EIRP) (e.g., a power budget at the satellite) and a maximum number of simultaneously illuminated beams (e.g., an RF chain limitation). Accordingly, as shown in FIG. 4B, the beam footprints 475 may include beam footprints 475a corresponding to active satellite beams (e.g., active downlink beams) and beam footprints 475b corresponding to inactive satellite beams (e.g., inactive downlink beams).

In some examples, an overhead of a downlink broadcast signal/channel (e.g., an overhead associated with SSB/PBCH and SIB1 transmissions) may be significant in an NTN deployment. In particular, even when specific downlink beams are not active for data transmission, the satellite network node may continuously transmit periodic SSB and SIB1 transmissions at a certain periodicity, which may result in a significant SSB/SIB1 transmission overhead. In 5G/NR, a periodicity for SSB/SIB1 transmissions may be 20 ms. In some examples, a periodicity for SSB/SIB1 transmissions may be increased in a power limited NTN deployment to decrease the SSB/SIB1 transmission overhead. For example, in an example NTN deployment with a 10% beam activity factor (e.g., 10% of the downlink beams may be simultaneously activated), the SSB transmission overhead for an SSB duration of 4 OFDM symbols and an SSB periodicity of 20 ms may be 14.3% of the system resources (e.g., of the power budget). In the example NTN deployment with the 10% beam activity factor, the SSB transmission overhead for the SSB duration of 4 OFDM symbols and an SSB periodicity of 160 ms may be reduced by a factor of 8 (as compared with the SSB periodicity of 20 ms) to 1.79% of the system resources (e.g., of the power budget). In the example NTN deployment with the 10% beam activity factor, the SSB+SIB1 transmission overhead for an SSB+SIB1 duration of 14 OFDM symbols and a periodicity of 20 ms may be 50% of the system resources (e.g., of the power budget). In the example NTN deployment with the 10% beam activity factor, the SSB+SIB1 transmission overhead for the SSB+SIB1 duration of 14 OFDM symbols and a periodicity of 160 ms may be reduced by a factor of 8 (as compared with the periodicity of 20 ms) to 6.25% of the system resources (e.g., of the power budget).

As indicated above, FIGS. 4A-4B are provided as examples. Other examples may differ from what is described with regard to FIGS. 4A-4B.

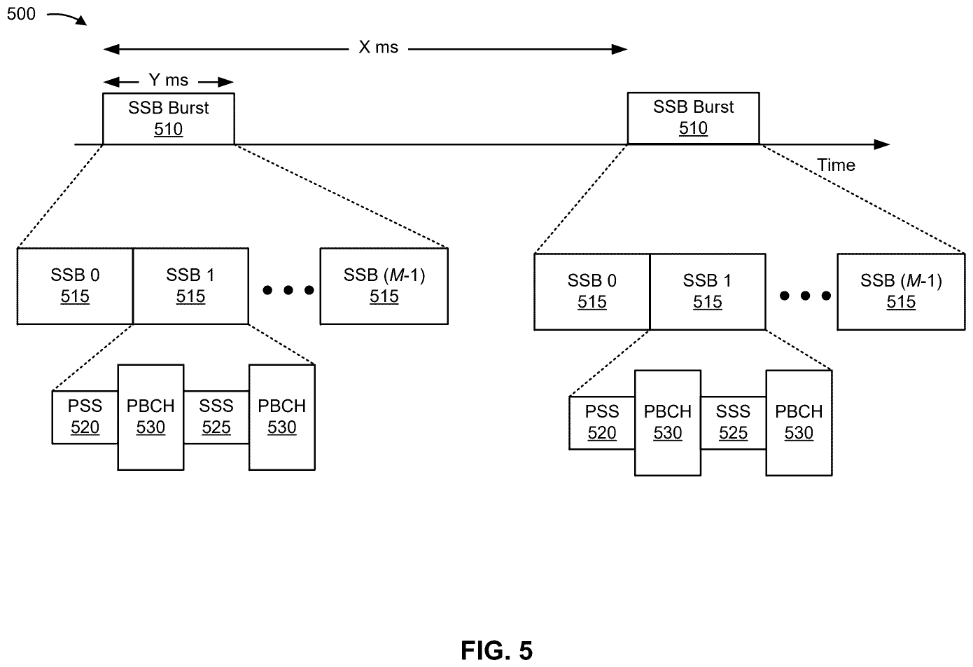

FIG. 5 is a diagram illustrating an example 500 of a synchronization signal (SS) hierarchy, in accordance with the present disclosure. As shown in FIG. 5, the SS hierarchy may include an SSB burst 510 that may be transmitted by one or more network nodes. As further shown, the SSB burst 510 may include one or more SSBs 515, shown as SSB 0 through SSB M−1, where M is a maximum number of SSBs 515 that can be carried by an SSB burst 510. In some aspects, different SSBs 515 may be beam-formed differently (e.g., transmitted using different beams), and may be used for cell search (e.g., initial cell search), cell acquisition, beam management, and/or beam selection (e.g., as part of an initial network access procedure). Additionally, or alternatively, the SSBs 515 may be used for a neighbor cell search (e.g., as part of a cell reselection or handover procedure). An SSB burst 510 may be periodically transmitted by a network node (e.g., a network node 110), such as every X milliseconds, as shown in FIG. 5. In some aspects, an SSB burst 510 may have a fixed or dynamic length, shown as Y milliseconds in FIG. 5. In some cases, an SSB burst 510 may be referred to as a discovery reference signal (DRS) transmission window or an SSB measurement time configuration (SMTC) window.

In some examples, an SSB 515 may include resources that carry a PSS 520, an SSS 525, and/or a PBCH 530. In some examples, multiple SSBs 515 may be included in an SSB burst 510 (e.g., with transmission on different beams), and the PSS 520, the SSS 525, and/or the PBCH 530 may be the same across each SSB 515 of the SSB burst 510. For example, an SSB burst 510 including multiple SSBs 515 transmitted on different beams may be used for SSB beam sweeping by a network node. In some examples, a single SSB 515 may be included in an SSB burst 510. In some examples, the SSB 515 may be four symbols (e.g., OFDM symbols) in length, where each symbol carries one or more of the PSS 520 (e.g., occupying one symbol), the SSS 525 (e.g., occupying one symbol), and/or the PBCH 530 (e.g., occupying two symbols). The PBCH 530 may carry an MIB. In some examples, an SSB 515 may be referred to as an SS/PBCH block.

In some examples, the symbols of an SSB 515 are consecutive, as shown in FIG. 5. In some other examples, the symbols of an SSB 515 are non-consecutive.

Similarly, in some examples, one or more SSBs 515 of the SSB burst 510 may be transmitted in consecutive radio resources (e.g., consecutive symbols) during one or more slots. Additionally, or alternatively, one or more SSBs 515 of the SSB burst 510 may be transmitted in non-consecutive radio resources.

In some examples, the SSB burst 510 may have an SSB burst periodicity (shown as X ms in FIG. 5), and the SSBs 515 of the SSB burst 510 may be transmitted by a wireless node (e.g., a network node 110) in accordance with to the SSB burst periodicity. In this case, the SSBs 515 may be repeated during each SSB burst 510. In some examples, the SSB burst periodicity may be 20 ms. In some other examples, such as in an NTN deployment, the SSB burst periodicity may be longer than 20 ms (e.g., 40 ms, 80 ms, or 160 ms, among other examples) to reduce an overhead associated with periodically transmitting the SSBs 515 of the SSB burst 510.

In some examples, an SSB 515 may include an SSB index, which may correspond to a beam used to carry the SSB 515. A UE 120 may monitor for and/or measure SSBs 515 using different Rx beams during an initial network access procedure and/or a cell search procedure, among other examples. Based at least in part on the monitoring and/or measuring, the UE 120 may indicate one or more SSBs 515 with a best signal parameter (e.g., an RSRP parameter) to a network node 110 (e.g., directly or via one or more other network nodes). The network node 110 and the UE 120 may use the one or more indicated SSBs 515 to select one or more beams to be used for communication between the network node 110 and the UE 120 (e.g., for a random access channel (RACH) procedure). Additionally, or alternatively, the UE 120 may use the SSB 515 and/or the SSB index to determine a cell timing for a cell via which the SSB 515 is received (e.g., a serving cell).

As indicated above, FIG. 5 is provided as an example. Other examples may differ from what is described with regard to FIG. 5.

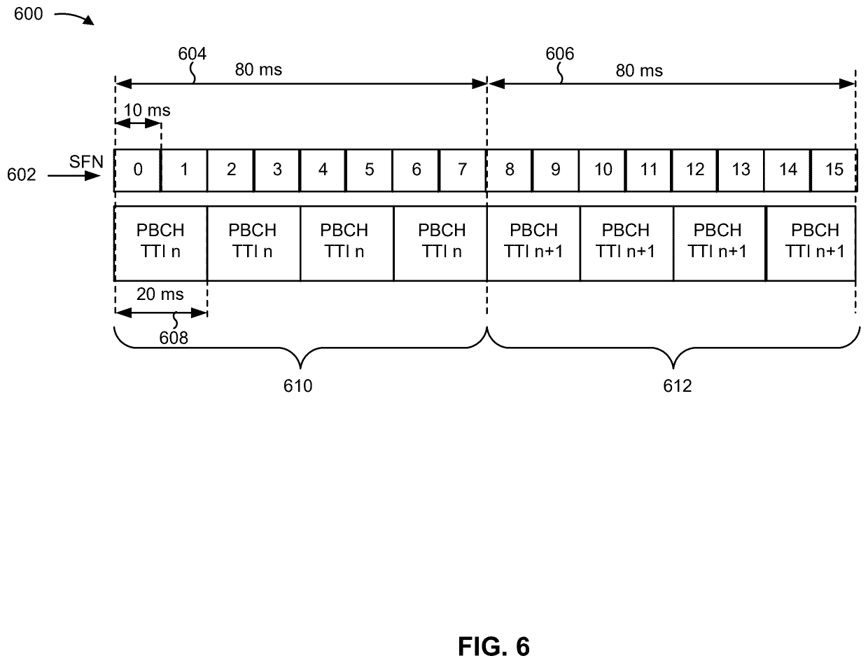

FIG. 6 is a diagram illustrating an example 600 associated with PBCH combining across SSB bursts, in accordance with the present disclosure. As shown in FIG. 6, example 600 includes radio frames (shown by reference number 602). The radio frames (sometimes referred to as “frames”) may be each associated with a respective system frame number (SFN). As shown in FIG. 6, each radio frame may have a duration of 10 ms. In some examples, for an initial cell search or a neighbor cell search in 5G NR, a UE (e.g., a UE 120) may assume that a PBCH is transmitted (e.g., in an SSB of an SSB burst) with a periodicity of 20 ms and with an 80 ms PBCH TTI. As shown by reference number 604, a first 80 ms PBCH TTI (PBCH TTI n) may correspond to radio frames 0-7 in example 600. As shown by reference number 606, a second 80 ms PBCH TTI (PBCH TTI n+1) may correspond to radio frames 8-15 in example 600. As shown by reference number 608, the PBCH may be transmitted (e.g., on a given beam) with a periodicity of 20 ms. For example, a PBCH in an SSB on a given beam may be transmitted in each transmission of an SSB burst, and the SSB burst periodicity may be 20 ms. Accordingly, as shown by reference number 610, four PBCH transmissions on a given beam may be included within PBCH TTI n. That is, four SSB bursts may be transmitted within PBCH TTI n, and each of the SSB bursts may include an SSB, including the PBCH, transmitted on a given beam. Similarly, as shown by reference number 612, four PBCH transmissions on a given beam may be included within PBCH TTI n+1. That is, four SSB bursts may be transmitted within PBCH TTI n+1, and each of the SSB bursts may include an SSB, including the PBCH, transmitted on a given beam.

The MIB payload of the PBCH transmitted in the SSB bursts is the same within the 80 ms PBCH TTI. Accordingly, in example 600, the MIB payload is the same in each PBCH transmitted within PBCH TTI n (e.g., in each PBCH transmitted in the four SSB bursts within PBCH TTI n). Similarly, the MIB payload is the same in each PBCH transmitted within PBCH TTI n+1 (e.g., in each PBCH transmitted in the four SSB bursts within PBCH TTI n+1). However, the MIB payload may be changed (e.g., by a network node) between PBCH TTI n and PBCH TTI n+1. For example, each PBCH transmitted within PBCH TTI n may include a first MIB payload, and each PBCH transmitted within PBCH TTI n+1 may include a second MIB payload. The transmission of PBCHs with the same payload in each of the four SSB bursts within an 80 ms PBCH TTI enables a UE to combine up to four PBCH transmissions within the PBCH TTI to decode the PBCH (e.g., to decode the MIB payload). For example, the UE may perform PBCH combining to combine PBCHs included in SSBs detected by the UE in all or a subset of the four SSB burst within the PBCH TTI. Such PBCH combining may be referred to as PBCH combining across SSB bursts (e.g., across SSB bursts within a PBCH TTI), PBCH combining within the PBCH TTI, or intra-TTI PBCH combining.

In some examples, the PBCH combining may include bit-level combining (e.g., log likelihood (LLR) combining) of demodulated bits of the PBCH transmissions received across the SSB bursts in the PBCH TTI. For example, the UE 120 may perform demodulation of the PBCH transmissions to obtain demodulated bits of the PBCH transmissions. The UE 120 may then perform bit-level combining (e.g., LLR combining) of the demodulated bits of the PBCH transmissions, and decoding of the combined bits (e.g., using a polar decoder) to obtain the MIB payload. In some examples, PBCH decoding performance with PBCH combining may be specified in a wireless communication standard (e.g., a 3GPP standard). In some examples, PBCH decoding using PBCH combining with multiple PBCH transmissions (e.g., 3 PBCHs or 4 PBCHs) across SSB bursts within a PBCH TTI may result in significant improvement in decoding performance (e.g., a significant reduction in block error rate (BLER)), as compared to PBCH decoding with a single PBCH transmission.

As discussed above in connection with FIG. 5, multiple SSBs may be transmitted within an SSB burst. A UE may assume that different SSBs within the SSB burst are transmitted with different beams. In some examples, the UE may opportunistically perform PBCH LLR combining of PBCH transmission within an SSB burst when multiple PSS/SSS peaks with legitimate SSB timing are detected, by the UE, within the SSB burst. However, with SSB beam sweeping (e.g., different SSBs in an SSB burst transmitted on different beams), detecting multiple PSS/SSS peaks with legitimate SSB timing within an SSB burst (e.g., detecting two SSBs within the SSB burst) may occur with a low probability, such as when the UE is located at a boundary between two SSB beams. Accordingly, the UE may rarely have the opportunity to perform PBCH combining using multiple PBCH transmissions within an SSB burst. In some examples, a PBCH decoding performance requirement specified in a wireless communication standard (e.g., a 3GPP standard) may not assume that a UE performs PBCH combining within an SSB burst.

In some examples, a wireless communication network may utilize an increased SSB burst periodicity (e.g., an SSB burst periodicity greater than 20 ms). For example, as discussed above in connection with FIG. 4B, an NTN deployment may utilize an increased SSB burst periodicity, as compared with a terrestrial network deployment, to reduce an SSB transmission overhead. In this case, the SSB burst periodicity in the NTN deployment may be greater than 20 ms (e.g., 40 ms, 80 ms, 160 ms, or 320 ms, among other examples) and/or greater than 40 ms (e.g., 80 ms, 160 ms, or 320 ms, among other examples). In some examples, such an increased SSB burst periodicity may be specified by a wireless communication standard (e.g., a 3GPP standard). However, such an increased SSB burst periodicity may reduce the number of SSB bursts within a PBCH TTI, which may reduce the intra-TTI PBCH combining that can be performed by the UE, resulting in the PBCH decoding performance of the UE being degraded. In an example in which the SSB burst periodicity is larger than 40 ms (e.g., 80 ms or 160 ms, among other examples) and the PBCH TTI is 80 ms, the PBCH decoding performance of the UE may be degraded because the UE cannot rely on intra-TTI PBCH decoding. The degradation of the PBCH decoding performance of the UE may result in a downlink coverage bottleneck (e.g., in an NTN deployment), for example, due to an increase in failed attempts to decode the PBCH and obtain the MIB. In some examples, a UE may pursue intra-SSB burst PBCH combining to recover the PBCH decoding performance degradation resulting from the reduction of intra-TTI PBCH combining. However, currently, the intra-SSB burst PBCH combining can only be performed opportunistically when multiple PSS/SSS peaks with legitimate SSB timing are detected in an SSB burst by the UE.

Various aspects relate generally to intra-SSB burst PBCH combining. Some aspects more specifically relate to an SSB transmission constraint for intra-SSB burst PBCH combining. In some aspects, a network node may transmit multiple SSBs in an SSB burst in accordance with an SSB burst periodicity. A UE may receive the multiple SSBs in the SSB burst. The multiple SSBs in the SSB burst may be subject to an SSB transmission constraint based at least in part on the SSB burst periodicity. For example, the SSB transmission constraint may be based at least in part on the SSB burst periodicity satisfying (e.g., being greater than) a periodicity threshold (e.g., 20 ms or 40 ms, among other examples). The UE may decode a PBCH using PBCH combining based at least in part respective PBCH transmissions included in the multiple SSBs in the SSB burst. In some aspects, the SSB transmission constraint may enable, improve, facilitate, and/or simplify the PBCH combining (e.g., the intra-SSB burst PBCH combining) performed by the UE. In this way, the UE may be enabled to reliably perform intra-SSB burst PBCH combining to decode the PBCH (e.g., in a scenario in which intra-TTI PBCH combining cannot be performed or is reduced due to a large SSB burst periodicity), which may improve the PBCH decoding performance of the UE.

As indicated above, FIG. 6 is provided as an example. Other examples may differ from what is described with respect to FIG. 6.

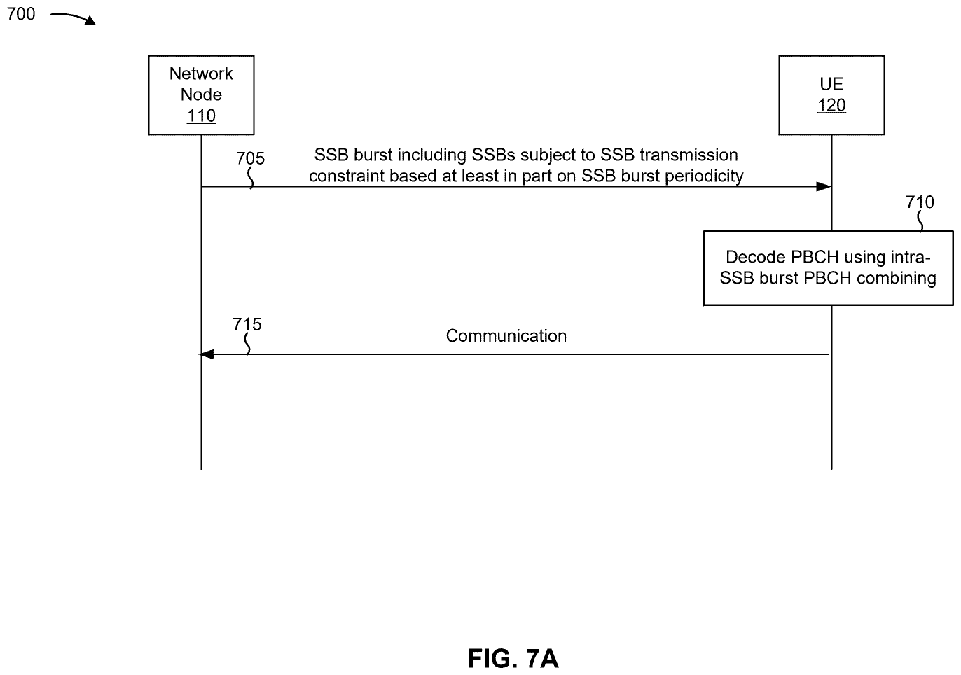

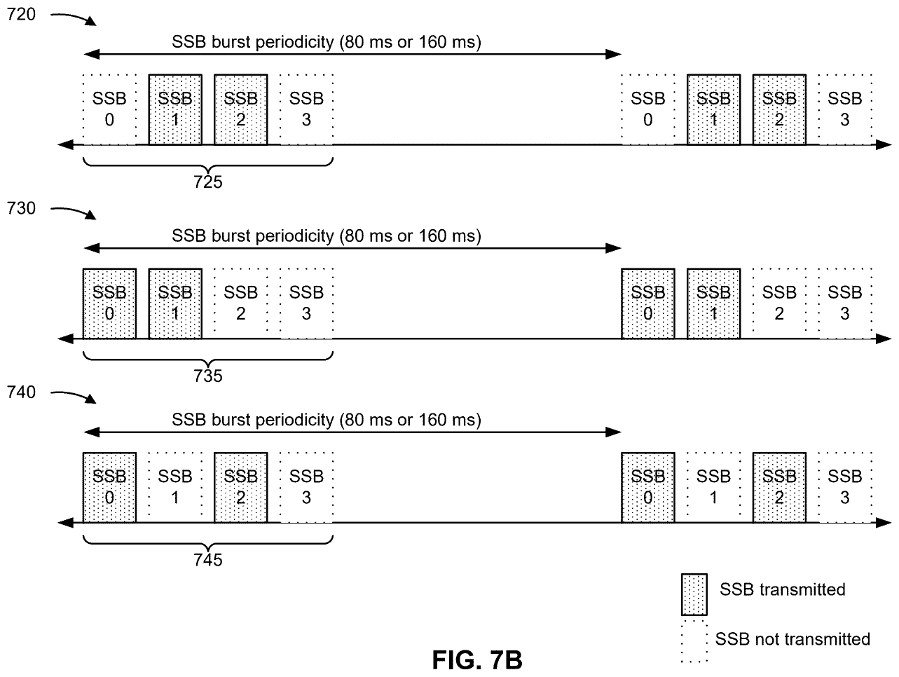

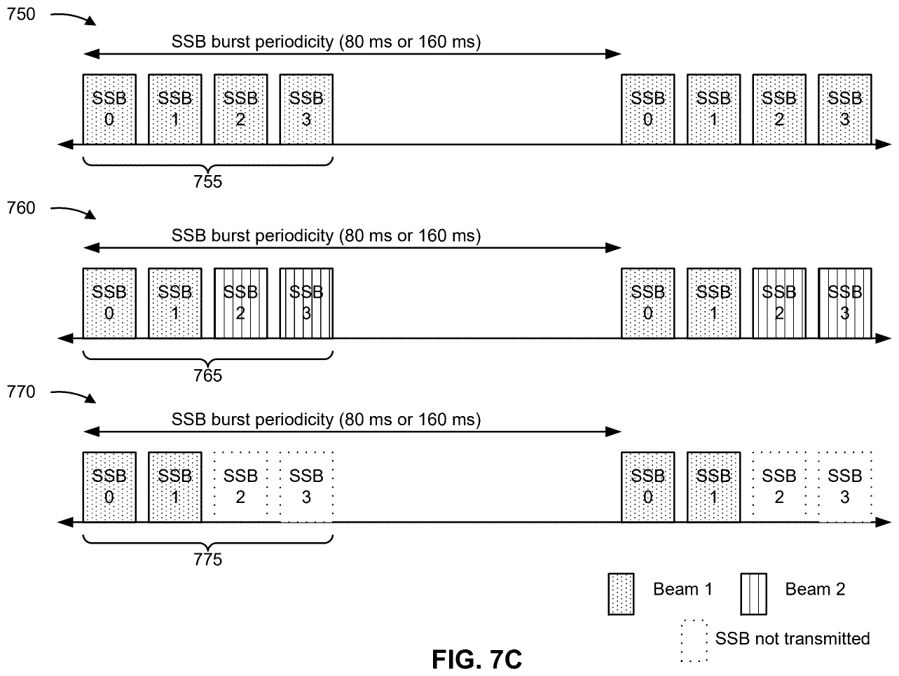

FIGS. 7A-7C are diagrams illustrating examples associated with an SSB transmission constraint for intra-SSB burst PBCH combining, in accordance with the present disclosure. As shown in FIG. 7A, example 700 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

In some aspects, the network node 110 may be an NTN network node, such as a satellite, deployed in an NTN associated with an increased SSB burst periodicity (e.g., an SSB burst periodicity greater than 20 ms), as compared with a terrestrial communication network. For example, the SSB burst periodicity in the NTN may be 40 ms, 80 ms, or 160 ms, among other examples. In such examples, the UE 120 may be an NTN UE (e.g., a UE capable of and/or configured (or pre-configured) to communicate via an NTN).

As shown in FIG. 7A, and by reference number 705, the network node 110 may transmit an SSB burst in accordance with an SSB burst periodicity associated with the SSB burst, and the SSB burst may include SSBs subject to an SSB transmission constraint based at least in part on the SSB burst periodicity associated with the SSB burst. In some aspects, the SSB burst may include a plurality of SSBs. That is, the network node 110 may transmit the plurality of SSBs in the SSB burst in accordance with the SSB burst periodicity, and the plurality of SSBs in the SSB burst may be subject to the SSB transmission constraint based at least in part on the SSB burst periodicity. The UE 120 may receive one or more of the SSBs in the SSB burst. In some aspects, the UE 120 may receive multiple SSBs of the plurality of SSBs in the SSB burst.

In some aspects, the SSB transmission constraint may be based at least in part on the SSB burst periodicity satisfying (e.g., being greater than) a first periodicity threshold. For example, the SSBs in the SSB burst may be subject to the SSB transmission constraint in connection with the SSB burst periodicity satisfying (e.g., being greater than) the first periodicity threshold. In some examples, the first periodicity threshold may be 20 ms. In such examples, the SSB transmission constraint may apply to SSBs in an SSB burst associated with an SSB burst periodicity that is greater than 20 ms (e.g., an SSB burst periodicity of 40 ms, 80 ms, or 160 ms, among other examples). That is, the SSBs in the SSB burst may be subject to the SSB transmission constraint in connection with the SSB burst periodicity associated with the SSB burst being greater than 20 ms. In some other examples, the first periodicity threshold may be 40 ms, such that the SSB transmission constraint applies to SSBs in an SSB burst associated with an SSB burst periodicity that is greater than 40 ms (e.g., an SSB burst periodicity of 80 ms or 160 ms, among other examples).

In some aspects, the SSB transmission constraint may be a constraint associated with the transmission of multiple SSBs in the SSB burst. In such examples, the SSBs in the SSB burst may be subject to the SSB transmission constraint in connection with the SSB burst satisfying (e.g., being greater than) the first periodicity threshold (e.g., 20 ms) and in connection with multiple SSBs being transmitted in the SSB burst. In some aspects, the SSB transmission constraint may be a constraint, associated with the transmission of multiple SSBs in the SSB burst, that enables, improves, facilitates, and/or simplifies intra-SSB burst PBCH combining by the UE 120 (e.g., in a case in which the UE 120 may not be able to rely on intra-TTI PBCH decoding using SSBs in different SSB bursts due to the SSB burst periodicity being greater than the first periodicity threshold).

In some aspects, the SSB transmission constraint may mandate that the multiple SSBs in the SSB burst be transmitted in adjacent SSB positions within the SSB burst. For example, for SSB transmissions (e.g., PBCH transmissions) within an SSB burst with an SSB burst periodicity that satisfies (e.g., is greater than) the first periodicity threshold (e.g., 20 ms), the SSB transmission constraint may mandate that adjacent SSBs within the SSB burst be transmitted if the network node 110 transmits multiple SSBs within the SSB burst. In such examples, the multiple SSBs transmitted by the network node 110 in the SSB burst, in accordance with the SSB transmission constraint, occupy adjacent SSB positions in the SSB burst. In some examples, a wireless communication standard (e.g., a 3GPP standard) may specify the SSB transmission constraint mandating that multiple SSBs, in an SSB burst with an SSB burst periodicity that satisfies the first periodicity threshold, be transmitted in adjacent SSB positions in the SSB burst. In some aspects, the SSB transmission constraint mandating that the multiple SSBs transmitted in the SSB burst occupy adjacent SSB positions in the SSB burst may enable the UE 120 to perform intra-SSB burst PBCH combining with a reduced number of combining hypotheses.

In some aspects, the SSB transmission constraint may permit the multiple SSBs in the SSB burst to occupy any adjacent SSB positions within the SSB burst. For example, in a case in which M SSBs are transmitted in the SSB burst (where M>1), the M transmitted SSBs, in accordance with the SSB transmission constraint, may occupy any M adjacent SSB positions within the SSB burst. In some other aspects, the SSB transmission constraint may mandate that the multiple SSBs in the SSB burst occupy SSB positions starting at a first SSB position in the SSB burst (e.g., the SSB position occurring first within the SSB burst). For example, in a case in which M SSBs are transmitted in the SSB burst (where M>1), the M transmitted SSBs, in accordance with the SSB transmission constraint, may occupy only a first M SSB positions within the SSB burst (e.g., M SSB positions starting at the first SSB position (in time) in the SSB burst).

FIG. 7B shows examples 720, 730, and 740 associated with an SSB transmission constraint that mandates that multiple SSBs (e.g., M SSBs) transmitted in an SSB burst occupy adjacent SSB positions. As shown in example 720, an SSB burst 725 is associated with an SSB periodicity (e.g., 80 ms or 160 ms) that satisfies (e.g., is greater than) the first periodicity threshold (e.g., 20 ms). The SSB burst 725 includes four SSB positions (e.g., respective SSB positions for SSB 0, SSB 1, SSB 2, and SSB 3), and two SSBs (SSB 1 and SSB 2) are transmitted in the SSB burst 725. The transmitted SSBs (SSB 1 and SSB 2) occupy a second SSB position and a third SSB position in the SSB burst 725. In a first case in which the SSB transmission constraint permits M transmitted SSBs in an SSB burst to occupy any M adjacent SSB positions in the SSB burst, the SSB burst 725 of example 720 satisfies the SSB transmission constraint, and the network node 110 is permitted to transmit the SSB burst 725 in accordance with the SSB transmission constraint. However, in a second case in which the SSB transmission constraint mandates that M transmitted SSBs in an SSB burst can only occupy M SSB positions starting at a first SSB position (e.g., SSB 0) in the SSB burst, the SSB burst 725 does not satisfy the SSB transmission constraint, and the network node 110 is not permitted to transmit the SSB burst 725 in accordance with the SSB transmission constraint.

As shown in example 730, an SSB burst 735 is associated with an SSB periodicity (e.g., 80 ms or 160 ms) that satisfies (e.g., is greater than) the first periodicity threshold (e.g., 20 ms). The SSB burst 735 includes four SSB positions (e.g., respective SSB positions for SSB 0, SSB 1, SSB 2, and SSB 3), and two SSBs (SSB 0 and SSB 1) are transmitted in the SSB burst 735. The transmitted SSBs (SSB 0 and SSB 1) occupy a first SSB position and a second SSB position in the SSB burst 735. In both the first case (in which the SSB transmission constraint permits M transmitted SSBs in an SSB burst to occupy any M adjacent SSB positions in the SSB burst) and the second case (in which the SSB transmission constraint mandates that M transmitted SSBs in an SSB burst can only occupy M SSB positions starting at a first SSB position in the SSB burst), the SSB burst 735 of example 730 satisfies the SSB transmission constraint, and the network node 110 is permitted to transmit the SSB burst 735 in accordance with the SSB transmission constraint.

As shown in example 740, an SSB burst 745 is associated with an SSB periodicity (e.g., 80 ms or 160 ms) that satisfies (e.g., is greater than) the first periodicity threshold (e.g., 20 ms). The SSB burst 745 includes four SSB positions (e.g., respective SSB positions for SSB 0, SSB 1, SSB 2, and SSB 3), and two SSBs (SSB 0 and SSB 2) are transmitted in the SSB burst 745. The transmitted SSBs (SSB 0 and SSB 2) occupy a first SSB position and a third SSB position in the SSB burst 745. That is, the transmitted SSBs do not occupy adjacent SSB positions in the SSB burst 745. Accordingly, in both the first case (in which the SSB transmission constraint permits M transmitted SSBs in an SSB burst to occupy any M adjacent SSB positions in the SSB burst) and the second case (in which the SSB transmission constraint mandates that M transmitted SSBs in an SSB burst can only occupy M SSB positions starting at a first SSB position in the SSB burst), the SSB burst 745 of example 740 does not satisfy the SSB transmission constraint, and the network node 110 is not permitted (shown by the X in FIG. 7B) to transmit the SSB burst 745 in accordance with the SSB transmission constraint.

In some aspects, the SSB transmission constraint may mandate a minimum number of SSBs to be transmitted in the SSB burst. The minimum number may be based at least in part on the SSB burst periodicity associated with the SSB burst. For example, the SSB transmission constraint may mandate that at least K (e.g., K=2) SSBs are transmitted in an SSB burst when the SSB burst periodicity satisfies (e.g., is greater than or equal to) a second periodicity threshold P (e.g., P=160 ms). In such examples, the multiple SSBs transmitted in the SSB burst, in accordance with the SSB transmission constraint, include at least the minimum number of SSBs (e.g., at least K SSBs), where the minimum number K is based at least in part on the SSB burst periodicity satisfying (e.g., being greater than or equal to) the second periodicity threshold P. In some examples, the second periodicity threshold P may be different from the first periodicity threshold discussed elsewhere herein. For example, the first periodicity threshold may be 20 ms or 40 ms, and the second periodicity threshold P may be 160 ms. In some other examples, the second periodicity threshold may be the same as the first periodicity threshold. In some aspects, the SSB transmission constraint mandating that at least K (e.g., K=2) SSBs are transmitted in an SSB burst when the SSB burst periodicity satisfies (e.g., is greater than or equal to) the second periodicity threshold P (e.g., P=160 ms) may ensure that the SSB burst may include multiple SSB transmissions, such that multiple PBCH transmissions (e.g., with the same MIB payload) are available for intra-PBCH combining by the UE 120, in a case in which the SSB burst periodicity is longer than the PBCH TTI.

In some aspects, the SSB transmission constraint may mandate that multiple SSBs in the SSB burst be associated with the same beam (e.g., transmitted using the same beam). For example, when a plurality of SSBs are transmitted in an SSB burst with an SSB burst periodicity that satisfies (e.g., is greater than) the first periodicity threshold (e.g., 20 ms), the SSB transmission constraint may mandate that the same beam be used for multiple SSBs of the plurality of SSBs within the SSB burst. In such examples, multiple SSBs transmitted by the network node 110 in the SSB burst, in accordance with the SSB transmission constraint, may be associated with the same beam. In some examples, a wireless communication standard (e.g., a 3GPP standard) may specify the SSB transmission constraint mandating that a same beam is used for multiple SSBs transmitted in an SSB burst with an SSB burst periodicity that satisfies the first periodicity threshold. In some aspects, the SSB transmission constraint mandating that a same beam be used for multiple SSBs transmitted in the SSB burst may enable the UE 120 to average a PBCH channel estimation across the multiple SSBs (in the SSB burst) that are associated with the same beam using DMRS bundling when performing intra-SSB burst PBCH combining to decode the PBCH.

In some aspects, the SSB transmission constraint may mandate that the same beam be used for all SSBs within the SSB burst. For example, the SSB burst may include a plurality of SSBs, and, in accordance with the SSB transmission constraint, the plurality of SSBs (e.g., all of the plurality of SSBs) may be associated with the same beam (e.g., may be transmitted using the same beam). FIG. 7C shows an example 750 associated with an SSB transmission constraint that mandates that all of a plurality of SSBs in an SSB burst be associated with a same beam. As shown in example 750, an SSB burst 755 is associated with an SSB periodicity (e.g., 80 ms or 160 ms) that satisfies (e.g., is greater than) the first periodicity threshold (e.g., 20 ms). The SSB burst 755 includes four SSBs (SSB 0, SSB 1, SSB 2, and SSB 3), and the four SSBs (SSB 0, SSB 1, SSB 2, and SSB 3), in accordance with the SSB transmission constraint, are associated with the same beam (e.g., beam 1). That is, the four SSBs (SSB 0, SSB 1, SSB 2, and SSB 3) in the SSB burst 755 are all transmitted by the network node 110 using the same beam in accordance with the SSB transmission constraint.

In some aspects, the SSB transmission constraint may mandate that the same beam be used for a group of SSBs (e.g., a group of multiple SSBs) included in the plurality of SSBs within the SSB burst. For example, the plurality of SSBs in the SSB burst may include one or more groups of SSBs (e.g., with each group of SSBs including two or more SSBs), and the SSBs in a given group of SSBs are associated with the same beam (e.g., the same beam is used for transmitting the group of SSBs). Each group of SSBs may be associated with a respective beam. FIG. 7C further shows examples 760 and 770 associated with an SSB transmission constraint that mandates that the same be used for a group SSBs included in the plurality of SSBs within an SSB burst. As shown in example 760, an SSB burst 765 is associated with an SSB periodicity (e.g., 80 ms or 160 ms) that satisfies (e.g., is greater than) the first periodicity threshold (e.g., 20 ms). The SSB burst 765 includes a first group of SSBs (SSB 0 and SSB 1) associated with a first beam (e.g., beam 1) and a second group of SSBs (SSB 2 and SSB 3) associated with a second beam (e.g., beam 2). In accordance with the SSB transmission constraint, the SSBs in the first group (e.g., SSB 0 and SSB 1) are each associated with the first beam (e.g., beam 1), and the SSBs in the second group (SSB 2 and SSB 3) are each associated with the second beam (e.g., beam 2).

As shown in example 770, an SSB burst 775 is associated with an SSB periodicity (e.g., 80 ms or 160 ms) that satisfies (e.g., is greater than) the first periodicity threshold (e.g., 20 ms). The SSB burst 775 includes a group of SSBs (SSB 0 and SSB 1) transmitted in the SSB burst 775, and SSB 2 and SSB 3 are not transmitted in the SSB burst 775. The SSBs (SSB 0 and SSB 1) in the group of SSBs included in the SSB burst 775, in accordance with the SSB transmission constraint, are associated with (e.g., transmitted using) the same beam (e.g., beam 1).

In some aspects, the SSB transmission constraint may include the SSB transmission constraint mandating that multiple SSBs transmitted the SSB burst occupy adjacent SSB positions in the SSB burst and/or the SSB transmission constraint mandating the same beam is used for multiple SSBs transmitted in the SSB burst, separately or in combination. In some aspects, the SSB transmission constraint may include the SSB transmission constraint mandating that at least K SSBs are transmitted in the SSB burst when the SSB burst periodicity satisfies (e.g., is greater than or equal to) the second periodicity threshold P together with the SSB transmission constraint mandating that multiple SSBs transmitted the SSB burst occupy adjacent SSB positions in the SSB burst and/or the SSB transmission constraint mandating the same beam is used for multiple SSBs transmitted in the SSB burst.

In some aspects, the UE 120 may receive multiple SSBs transmitted in the SSB burst during an initial cell search (e.g., for establishing a connection with the network node 110). In some aspects, in a case in which the SSBs subject to the SSB transmission constraint are used for an initial cell search by the UE 120, the SSB transmission constraint may be specified in a wireless communication standard (e.g., a 3GPP standard), and/or the SSB transmission constraint may be preconfigured in the UE 120. In some aspects, the SSB transmission constraint may be associated with a dedicated NTN synchronization raster associated with the SSB burst periodicity (e.g., an SSB burst periodicity that is greater than 20 ms). A synchronization raster indicates (or represents) frequency locations for reception, by the UE 120, of SSBs during the initial cell search (e.g., frequency locations where the UE 120 is expected to receive one or more SSBs during the initial cell search). The dedicated NTN synchronization raster indicates (or represents) a dedicated set of frequency locations for reception of SSBs in an NTN associated with the SSB burst periodicity (e.g., an NTN in which the SSB burst periodicity is greater than 20 ms). Accordingly, in some examples, the SSB transmission constraint may be associated with a dedicated set of frequency locations for reception of SSBs in an NTN associated with the SSB burst periodicity. In some aspects, for an initial cell search, the SSB transmission constraint may be associated with a dedicated NTN synchronization raster associated with the SSB burst periodicity (e.g., the SSB burst periodicity that is greater than 20 ms) in a wireless communication standard (e.g., a 3GPP standard). In some aspects, for an initial cell search, the SSB transmission constraint may be associated with a dedicated NTN synchronization raster associated with the SSB burst periodicity (e.g., the SSB burst periodicity that is greater than 20 ms), and pre-configured in the UE 120 (e.g., the NTN UE). In some examples, without the SSB transmission constraint being specified in a wireless communication standard (e.g., a 3GPP standard) or pre-configuration of the SSB transmission constraint in the UE 120 (e.g., the NTN UE), the UE 120 may not assume, for the initial cell search, that the SSB transmission constraint is applicable to the SSB transmissions.

In some aspects, the UE 120 may receive multiple SSBs transmitted in the SSB burst during a neighbor cell search in an idle or inactive mode. In such examples, the SSBs in the SSB burst may be associated with a neighbor cell to a current serving cell on which the UE 120 is camped, and the UE 120 may receive, via the current serving cell (e.g., in system information of the current serving cell), an indication of the SSB transmission constraint for the SSBs associated with the neighbor cell. In such examples, the network node 110 that transmits the SSBs in the SSB burst may be associated with the neighbor cell, and the UE 120 may receive the indication of the SSB transmission constraint from a network node associated with the current serving cell. In some aspects, the UE 120 may receive, via the current serving cell, an indication of the SSB transmission constraint for the neighbor cell search in the idle or inactive mode in system information associated with a neighbor cell. For example, the indication of the SSB transmission constraint may be included in SIB type 3 (SIB3) or SIB type 4 (SIB4). In some examples, the SSB transmission constraint may be indicated in SIB3 per intra-frequency target frequency layer or in SIB4 per inter-frequency target frequency layer. In some other aspects, the UE 120 may receive, via the current serving cell, an indication of the SSB transmission constraint for the neighbor cell search in the idle or inactive mode in system information associated with a neighbor satellite (e.g., in an NTN). For example, the indication of the SSB transmission constraint may be included in neighbor satellite information in SIB type 19 (SIB19). In some aspects, without an explicit indication (e.g., in SIB3, SIB4, or SIB19) of the SSB transmission constraint for the neighbor cell search in the idle or inactive mode, the UE 120 may assume that the SSB transmission constraint for the neighbor cell search in the idle or inactive mode is the same as the SSB transmission constraint for the initial cell search.

In some aspects, the UE 120 may receive multiple SSBs transmitted in the SSB burst during a neighbor cell search in a connected mode. In such examples, the SSBs in the SSB burst may be associated with a neighbor cell to a current serving cell for the UE 120, and the UE 120 may receive, via the current serving cell, an indication of the SSB transmission constraint for the SSBs associated with the neighbor cell. In such examples, the network node 110 that transmits the SSBs in the SSB burst may be associated with the neighbor cell, and the UE 120 may receive the indication of the SSB transmission constraint from a network node associated with the current serving cell. In some aspects, the UE 120 may receive, via the current serving cell, an indication of the SSB transmission constraint for the neighbor cell search in the connected mode in a measurement object (MO) configuration associated with a measurement of the neighbor cell. For example, the SSB transmission constraint may be indicated in the MO configuration per target frequency layer. In some other aspects, the UE 120 may receive, via the current serving cell, an indication of the SSB transmission constraint for the neighbor cell search in the connected mode in system information associated with a neighbor satellite (e.g., in an NTN). For example, the indication of the SSB transmission constraint may be included in neighbor satellite information in SIB19. In some aspects, without an explicit indication (e.g., in an MO configuration or SIB19) of the SSB transmission constraint for the neighbor cell search in the connected mode, the UE 120 may assume that the SSB transmission constraint for the neighbor cell search in the connected mode is the same as the SSB transmission constraint for the initial cell search.

As further shown in FIG. 7A, and by reference number 710, the UE 120 may decode a PBCH using intra-SSB burst PBCH combining. The network node 110 may transmit a plurality of SSBs in the SSB burst, subject to the SSB transmission constraint, as described in connection with reference number 705. The UE 120 may receive multiple SSBs of the plurality of SSBs transmitted in the SSB burst. For example, the multiple SSBs, in the SSB burst, received by the UE 120 may include all or a subset of the plurality of SSBs transmitted in the SSB burst by the network node 110. The UE 120 may decode the PBCH using PBCH combining based at least in part on respective PBCH transmissions included in the multiple SSBs, in the SSB burst, received by the UE 120.

In some aspects, the UE 120 may perform PBCH LLR combining based at least in part on the respective PBCH transmissions included in the multiple SSBs in the SSB burst to decode the PBCH (e.g., to decode an MIB payload of the PBCH). The respective PBCH transmissions included in the multiple SSBs in the SSB burst may include the same MIB payload. In some examples, the PBCH LLR combining may include bit-level combining of demodulated bits (e.g., LLRs) of the respective PBCH transmissions included in the multiple SSBs in the SSB burst. For example, the UE 120 may perform demodulation of each of the respective PBCH transmissions included in the multiple SSBs in the SSB burst to obtain demodulated bits (e.g., LLRs) of the respective PBCH transmissions included in the multiple SSBs in the SSB burst. The UE 120 may then perform bit-level combining of the demodulated bits (e.g., LLRs) of the respective PBCH transmissions included in the multiple SSBs in the SSB burst, and decoding of the combined bits to obtain the MIB payload.

In some aspects, the UE 120 may perform the intra-SSB burst PBCH combining based at least in part on the SSB transmission constraint applied to the multiple SSBs in the SSB burst. For example, the UE 120 may utilize knowledge of the SSB transmission constraint (e.g., the specification of the SSB transmission constraint in a wireless communication standard, pre-configuration of the SSB transmission constraint in the UE 120, and/or an indication of the SSB transmission constraint received by the UE 120) when performing the intra-SSB burst PBCH combining (and/or to determine to perform the intra-SSB burst PBCH combining). In some examples, the SSB transmission constraint may enable, improve, facilitate, and/or simplify the intra-SSB burst PBCH combining performed by the UE 120.

In some aspects, in a case in which the SSB transmission constraint mandates that the multiple SSBs transmitted in the SSB burst occupy adjacent SSB positions in the SSB burst, the SSB transmission constraint may enable the UE 120 to perform the intra-SSB burst PBCH combining with a reduced number of combining hypotheses. In such examples, because the multiple SSBs occupy adjacent SSB positions in the SSB burst, when the UE 120 detects an SSB in the SSB burst, the UE 120 may then attempt combining the detected SSB with an SSB in an adjacent SSB position (e.g., a previous SSB position and/or a next SSB position) in the SSB burst. That is, the combining hypotheses considered by the UE 120 for the PBCH combining may be limited to the previous SSB position and/or the next SSB position, thus simplifying a PBCH combining algorithm performed by the UE 120.

In some aspects, in a case in which the SSB transmission constraint mandates that a same beam be used for multiple SSBs in the SSB burst, the UE 120 may average a PBCH channel estimation across the multiple SSBs (in the SSB burst) that are associated with the same beam using DMRS bundling when performing channel estimation as part of the intra-SSB burst PBCH combining. This may result in improved channel estimation, which may improve the PBCH decoding performance of the intra-SSB burst PBCH combining.

As further shown FIG. 7A, and by reference number 715, the UE 120 may transmit, and the network node 110 may receive, a communication based at least in part on decoding the PBCH. The UE 120 may obtain the MIB by decoding the PBCH, and the UE 120 may receive SIB1 based at least in part on the information included in the MIB. In some aspects, the communication transmitted by the UE 120 based at least in part on decoding the PBCH may be a communication associated with an initial access procedure (e.g., a random access procedure) to establish a connection between the UE 120 and the network node 110. For example, the communication may be a message 1 of a four-step random access procedure, and message A of a two-step random access procedure, or another communication (e.g., a RACH communication) associated with an initial access procedure or a random access procedure. In some aspects, in the case of a neighbor cell search (e.g., a neighbor cell search in the idle or inactive mode or a neighbor cell search in the connected mode), the communication may be a communication associated with switching from a current serving cell to a neighbor cell associated with the network node 110.

As indicated above, FIGS. 7A-7C are provided as examples. Other examples may differ from what is described with respect to FIGS. 7A-7C.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with an SSB transmission constraint for intra-SSB burst PBCH combining.

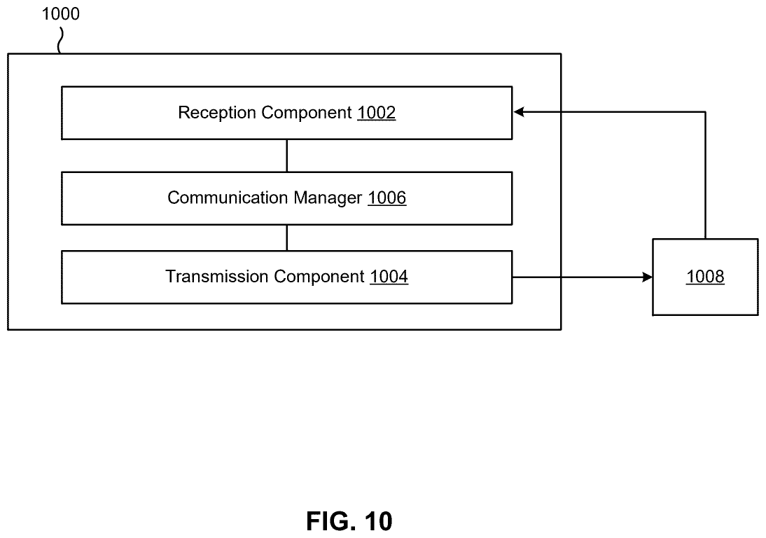

As shown in FIG. 8, in some aspects, process 800 may include receiving multiple SSBs in an SSB burst, where the multiple SSBs in the SSB burst are subject to an SSB transmission constraint based at least in part on an SSB burst periodicity associated with the SSB burst (block 810). For example, the UE (e.g., using reception component 1002 and/or communication manager 1006, depicted in FIG. 10) may receive multiple SSBs in an SSB burst, wherein the multiple SSBs in the SSB burst are subject to an SSB transmission constraint based at least in part on an SSB burst periodicity associated with the SSB burst, as described above. In some aspects, the reception of the multiple SSBs in the SSB burst may be performed in a manner similar to reception of the multiple SSBs in the SSB burst described in connection with reference number 705 of FIG. 7A. The SSB transmission constraint may be similar to that described in connection with reference number 705 of FIG. 7A, in connection with FIG. 7B, and/or in connection with FIG. 7C.

As further shown in FIG. 8, in some aspects, process 800 may include decoding a PBCH using PBCH combining based at least in part on respective PBCH transmissions included in the multiple SSBs in the SSB burst (block 820). For example, the UE (e.g., using communication manager 1006, depicted in FIG. 10) may decode a PBCH using PBCH combining based at least in part on respective PBCH transmissions included in the multiple SSBs in the SSB burst, as described above. In some aspects, the decoding of the PBCH using PBCH combining based at least in part on respective PBCH transmissions included in the multiple SSBs in the SSB burst may be performed in a manner similar to reception of the decoding of the PBCH using intra-SSB burst PBCH combining described in connection with reference number 710 of FIG. 7A.

Process 800 may include additional aspects, such as any single aspect or any combination of aspects described below and/or in connection with one or more other processes described elsewhere herein.

In a first aspect, the SSB transmission constraint is based at least in part on the SSB burst periodicity satisfying a periodicity threshold, e.g., as described in connection with FIGS. 7A-7C.

In a second aspect, alone or in combination with the first aspect, the SSB transmission constraint is based at least in part on the SSB burst periodicity being greater than 20 milliseconds, e.g., as described in connection with FIGS. 7A-7C.

In a third aspect, alone or in combination with one or more of the first and second aspects, the multiple SSBs, in accordance with the SSB transmission constraint, occupy adjacent SSB positions in the SSB burst, e.g., as described in connection with FIGS. 7A-7C.

In a fourth aspect, alone or in combination with one or more of the first through third aspects, the SSB burst includes M SSBs, M is greater than one, and the M SSBs, in accordance with the SSB transmission constraint, occupy M adjacent SSB positions starting at a first SSB position in the SSB burst, e.g., as described in connection with FIGS. 7A-7C.

In a fifth aspect, alone or in combination with one or more of the first through fourth aspects, the multiple SSBs, in accordance with the SSB transmission constraint, include at least a minimum number of SSBs in the SSB burst, wherein the minimum number is based at least in part on the SSB burst periodicity satisfying a periodicity threshold, e.g., as described in connection with FIGS. 7A-7C.

In a sixth aspect, alone or in combination with one or more of the first through fifth aspects, the multiple SSBs in the SSB burst, in accordance with the SSB transmission constraint, are associated with a same beam, e.g., as described in connection with FIGS. 7A-7C.

In a seventh aspect, alone or in combination with one or more of the first through sixth aspects, SSBs in the SSB burst, in accordance with the SSB transmission constraint, are associated with the same beam, e.g., as described in connection with FIGS. 7A-7C.

In an eighth aspect, alone or in combination with one or more of the first through seventh aspects, the multiple SSBs are included in a group of SSBs among one or more groups of SSBs included in the SSB burst, and the SSBs in the group of SSBs, in accordance with the SSB transmission constraint, are associated with the same beam, e.g., as described in connection with FIGS. 7A-7C.

In a ninth aspect, alone or in combination with one or more of the first through eighth aspects, decoding the PBCH using PBCH combining includes averaging a PBCH channel estimation across the multiple SSBs, associated with the same beam, using DMRS bundling, e.g., as described in connection with FIGS. 7A-7C.

In a tenth aspect, alone or in combination with one or more of the first through ninth aspects, the SSB transmission constraint is associated with a dedicated set of frequency locations for reception of SSBs in an NTN associated with the SSB burst periodicity, e.g., as described in connection with FIGS. 7A-7C.

In an eleventh aspect, alone or in combination with one or more of the first through tenth aspects, process 800 includes receiving, via a current serving cell, an indication of the SSB transmission constraint in system information associated with a neighbor cell, wherein the multiple SSBs in the SSB burst are associated with the neighbor cell, e.g., as described in connection with FIGS. 7A-7C.

In a twelfth aspect, alone or in combination with one or more of the first through eleventh aspects, the indication of SSB transmission constraint is included in a SIB3 or a SIB4, e.g., as described in connection with FIGS. 7A-7C.

In a thirteenth aspect, alone or in combination with one or more of the first through twelfth aspects, process 800 includes receiving an indication of the SSB transmission constraint in a measurement object configuration associated with a measurement of a neighbor cell, wherein the multiple SSBs in the SSB burst are associated with the neighbor cell, e.g., as described in connection with FIGS. 7A-7C.

In a fourteenth aspect, alone or in combination with one or more of the first through thirteenth aspects, process 800 includes receiving, via a current serving cell, an indication of the SSB transmission constraint in system information associated with a neighbor satellite, wherein the multiple SSBs in the SSB burst are associated with a neighbor non-terrestrial cell, e.g., as described in connection with FIGS. 7A-7C.

In a fifteenth aspect, alone or in combination with one or more of the first through fourteenth aspects, the indication of the SSB transmission constraint is included in a SIB19, e.g., as described in connection with FIGS. 7A-7C.

In a sixteenth aspect, alone or in combination with one or more of the first through fifteenth aspects, process 800 includes transmitting, to a network node, a communication based at least in part on decoding the PBCH, e.g., as described in connection with FIGS. 7A-7C.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with an SSB transmission constraint for intra-SSB burst PBCH combining.

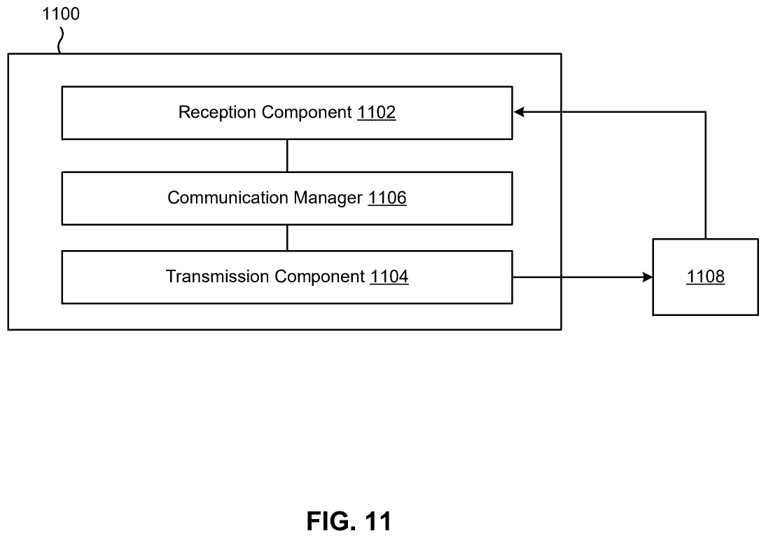

As shown in FIG. 9, in some aspects, process 900 may include transmitting multiple SSBs in an SSB burst in accordance with an SSB burst periodicity, where the multiple SSBs in the SSB burst are subject to an SSB transmission constraint based at least in part on the SSB burst periodicity (block 910). For example, the network node (e.g., using transmission component 1104 and/or communication manager 1106, depicted in FIG. 11) may transmit multiple SSBs in an SSB burst in accordance with an SSB burst periodicity, wherein the multiple SSBs in the SSB burst are subject to an SSB transmission constraint based at least in part on the SSB burst periodicity, as described above. In some aspects, the transmission of the multiple SSBs in the SSB burst may be performed in a manner similar to transmission of the multiple SSBs in the SSB burst described in connection with reference number 705 of FIG. 7A. The SSB transmission constraint may be similar to that described in connection with reference number 705 of FIG. 7A, in connection with FIG. 7B, and/or in connection with FIG. 7C.

As further shown in FIG. 9, in some aspects, process 900 may include receiving, from a UE, a communication based at least in part on at least one of the multiple SSBs in the SSB burst (block 920). For example, the network node (e.g., using reception component 1102 and/or communication manager 1106, depicted in FIG. 11) may receive, from a UE, a communication based at least in part on at least one of the multiple SSBs in the SSB burst, as described above. In some aspects, the reception of the communication based at least in part on at least one of the multiple SSBs in the SSB burst may be performed in a manner similar to the reception of the communication based at least in part on at least one of the multiple SSBs in the SSB burst described in connection with reference number 715 of FIG. 7A.

Process 900 may include additional aspects, such as any single aspect or any combination of aspects described below and/or in connection with one or more other processes described elsewhere herein.

In a first aspect, the SSB transmission constraint is based at least in part on the SSB burst periodicity satisfying a periodicity threshold, e.g., as described in connection with FIGS. 7A-7C.

In a second aspect, alone or in combination with the first aspect, the SSB transmission constraint is based at least in part on the SSB burst periodicity being greater than 20 milliseconds, e.g., as described in connection with FIGS. 7A-7C.

In a third aspect, alone or in combination with one or more of the first and second aspects, the multiple SSBs, in accordance with the SSB transmission constraint, occupy adjacent SSB positions in the SSB burst, e.g., as described in connection with FIGS. 7A-7C.

In a fourth aspect, alone or in combination with one or more of the first through third aspects, the multiple SSBs in the SSB burst include M SSBs, M is greater than one, and the M SSBs, in accordance with the SSB transmission constraint, occupy M adjacent SSB positions starting at a first SSB position in the SSB burst, e.g., as described in connection with FIGS. 7A-7C.

In a fifth aspect, alone or in combination with one or more of the first through fourth aspects, the multiple SSBs, in accordance with the SSB transmission constraint, include at least a minimum number of SSBs in the SSB burst, wherein the minimum number is based at least in part on the SSB burst periodicity satisfying a periodicity threshold, e.g., as described in connection with FIGS. 7A-7C.

In a sixth aspect, alone or in combination with one or more of the first through fifth aspects, the multiple SSBs in the SSB burst, in accordance with the SSB transmission constraint, are associated with a same beam, e.g., as described in connection with FIGS. 7A-7C.

In a seventh aspect, alone or in combination with one or more of the first through sixth aspects, the multiple SSBs in the SSB burst include one or more groups of SSBs, and in accordance with the SSB transmission constraint, the SSBs in a group of SSBs, of the one or more groups of SSBs, are associated with a same beam, e.g., as described in connection with FIGS. 7A-7C.

In an eighth aspect, alone or in combination with one or more of the first through seventh aspects, the multiple SSBs in the SSB burst include a first group of SSBs associated with a first beam and a second group of SSBs associated with a second beam, e.g., as described in connection with FIGS. 7A-7C.

In a ninth aspect, alone or in combination with one or more of the first through eighth aspects, the SSB transmission constraint is associated with a dedicated set of frequency locations for reception of SSBs in an NTN associated with the SSB burst periodicity, e.g., as described in connection with FIGS. 7A-7C.

In a tenth aspect, alone or in combination with one or more of the first through ninth aspects, the SSB transmission constraint is indicated in system information of a first cell, and the multiple SSBs in the SSB burst are associated with a second cell, e.g., as described in connection with FIGS. 7A-7C.

In an eleventh aspect, alone or in combination with one or more of the first through tenth aspects, the SSB transmission constraint is indicated in a SIB3, a SIB4, or a SIB19 of the first cell, e.g., as described in connection with FIGS. 7A-7C.

In a twelfth aspect, alone or in combination with one or more of the first through eleventh aspects, the SSB transmission constraint is indicated in a measurement object configuration of a first cell, and the multiple SSBs in the SSB burst are associated with a second cell, e.g., as described in connection with FIGS. 7A-7C.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 7A-7C. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive multiple SSBs in an SSB burst, wherein the multiple SSBs in the SSB burst are subject to an SSB transmission constraint based at least in part on an SSB burst periodicity associated with the SSB burst. The communication manager 1006 may decode a PBCH using PBCH combining based at least in part on respective PBCH transmissions included in the multiple SSBs in the SSB burst.

The reception component 1002 may receive, via a current serving cell, an indication of the SSB transmission constraint in system information associated with a neighbor cell, wherein the multiple SSBs in the SSB burst are associated with the neighbor cell.

The reception component 1002 may receive an indication of the SSB transmission constraint in a measurement object configuration associated with a measurement of a neighbor cell, wherein the multiple SSBs in the SSB burst are associated with the neighbor cell.

The reception component 1002 may receive, via a current serving cell, an indication of the SSB transmission constraint in system information associated with a neighbor satellite, wherein the multiple SSBs in the SSB burst are associated with a neighbor non-terrestrial cell.

The transmission component 1004 may transmit, to a network node, a communication based at least in part on decoding the PBCH.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A-7C. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit multiple SSBs in an SSB burst in accordance with an SSB burst periodicity, wherein the multiple SSBs in the SSB burst are subject to an SSB transmission constraint based at least in part on the SSB burst periodicity. The reception component 1102 may receive, from a UE, a communication based at least in part on at least one of the multiple SSBs in the SSB burst.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving multiple synchronization signal blocks (SSBs) in an SSB burst, wherein the multiple SSBs in the SSB burst are subject to an SSB transmission constraint based at least in part on an SSB burst periodicity associated with the SSB burst; and decoding a physical broadcast channel (PBCH) using PBCH combining based at least in part on respective PBCH transmissions included in the multiple SSBs in the SSB burst.

Aspect 2: The method of Aspect 1, wherein the SSB transmission constraint is based at least in part on the SSB burst periodicity satisfying a periodicity threshold.

Aspect 3: The method of any of Aspects 1-2, wherein the SSB transmission constraint is based at least in part on the SSB burst periodicity being greater than 20 milliseconds.

Aspect 4: The method of any of Aspects 1-3, wherein the multiple SSBs, in accordance with the SSB transmission constraint, occupy adjacent SSB positions in the SSB burst.

Aspect 5: The method of any of Aspects 1-4, wherein the SSB burst includes M SSBs, wherein M is greater than one, and wherein the M SSBs, in accordance with the SSB transmission constraint, occupy M adjacent SSB positions starting at a first SSB position in the SSB burst.

Aspect 6: The method of any of Aspects 1-5, wherein the multiple SSBs, in accordance with the SSB transmission constraint, include at least a minimum number of SSBs in the SSB burst, wherein the minimum number is based at least in part on the SSB burst periodicity satisfying a periodicity threshold.

Aspect 7: The method of any of Aspects 1-6, wherein the multiple SSBs in the SSB burst, in accordance with the SSB transmission constraint, are associated with a same beam.

Aspect 8: The method of Aspect 7, wherein SSBs in the SSB burst, in accordance with the SSB transmission constraint, are associated with the same beam.

Aspect 9: The method of Aspect 7, wherein the multiple SSBs are included in a group of SSBs among one or more groups of SSBs included in the SSB burst, and wherein the SSBs in the group of SSBs, in accordance with the SSB transmission constraint, are associated with the same beam.

Aspect 10: The method of any of Aspects 7-9, wherein decoding the PBCH using PBCH combining comprises: averaging a PBCH channel estimation across the multiple SSBs, associated with the same beam, using demodulation reference signal (DMRS) bundling.

Aspect 11: The method of any of Aspects 1-10, wherein the SSB transmission constraint is associated with a dedicated set of frequency locations for reception of SSBs in a non-terrestrial network (NTN) associated with the SSB burst periodicity.

Aspect 12: The method of any of Aspects 1-10, further comprising: receiving, via a current serving cell, an indication of the SSB transmission constraint in system information associated with a neighbor cell, wherein the multiple SSBs in the SSB burst are associated with the neighbor cell.

Aspect 13: The method of Aspect 12, wherein the indication of SSB transmission constraint is included in a system information block (SIB) type 3 (SIB3) or a SIB type 4 (SIB4).

Aspect 14: The method of any of Aspects 1-10, further comprising: receiving an indication of the SSB transmission constraint in a measurement object configuration associated with a measurement of a neighbor cell, wherein the multiple SSBs in the SSB burst are associated with the neighbor cell.

Aspect 15: The method of any of Aspects 1-10, further comprising: receiving, via a current serving cell, an indication of the SSB transmission constraint in system information associated with a neighbor satellite, wherein the multiple SSBs in the SSB burst are associated with a neighbor non-terrestrial cell.

Aspect 16: The method of Aspect 15, wherein the indication of the SSB transmission constraint is included in a system information block (SIB) type 19 (SIB19).

Aspect 17: The method of any of Aspects 1-16, further comprising: transmitting, to a network node, a communication based at least in part on decoding the PBCH.

Aspect 18: A method of wireless communication performed by a network node, comprising: transmitting multiple synchronization signal blocks (SSBs) in an SSB burst in accordance with an SSB burst periodicity, wherein the multiple SSBs in the SSB burst are subject to an SSB transmission constraint based at least in part on the SSB burst periodicity; and receiving, from a user equipment (UE), a communication based at least in part on at least one of the multiple SSBs in the SSB burst.

Aspect 19: The method of Aspect 18, wherein the SSB transmission constraint is based at least in part on the SSB burst periodicity satisfying a periodicity threshold.

Aspect 20: The method of any of Aspects 18-19, wherein the SSB transmission constraint is based at least in part on the SSB burst periodicity being greater than 20 milliseconds.

Aspect 21: The method of any of Aspects 18-20, wherein the multiple SSBs, in accordance with the SSB transmission constraint, occupy adjacent SSB positions in the SSB burst.

Aspect 22: The method of any of Aspects 18-21, wherein the multiple SSBs in the SSB burst include M SSBs, wherein M is greater than one, and wherein the M SSBs, in accordance with the SSB transmission constraint, occupy M adjacent SSB positions starting at a first SSB position in the SSB burst.

Aspect 23: The method of any of Aspects 18-22, wherein the multiple SSBs, in accordance with the SSB transmission constraint, include at least a minimum number of SSBs in the SSB burst, wherein the minimum number is based at least in part on the SSB burst periodicity satisfying a periodicity threshold.

Aspect 24: The method of any of Aspects 18-23, wherein the multiple SSBs in the SSB burst, in accordance with the SSB transmission constraint, are associated with a same beam.

Aspect 25: The method of any of Aspects 18-23, wherein the multiple SSBs in the SSB burst include one or more groups of SSBs, and wherein, in accordance with the SSB transmission constraint, the SSBs in a group of SSBs, of the one or more groups of SSBs, are associated with a same beam.

Aspect 26: The method of Aspect 25, wherein the multiple SSBs in the SSB burst include a first group of SSBs associated with a first beam and a second group of SSBs associated with a second beam.

Aspect 27: The method of any of Aspects 18-26, wherein the SSB transmission constraint is associated with a dedicated set of frequency locations for reception of SSBs in a non-terrestrial network (NTN) associated with the SSB burst periodicity.

Aspect 28: The method of any of Aspects 18-26, wherein the SSB transmission constraint is indicated in system information of a first cell, and wherein the multiple SSBs in the SSB burst are associated with a second cell.

Aspect 29: The method of Aspect 28, wherein the SSB transmission constraint is indicated in a system information block (SIB) type 3 (SIB3), a SIB type 4 (SIB4), or a SIB type 19 (SIB19) of the first cell.

Aspect 30: The method of any of Aspects 18-26, wherein the SSB transmission constraint is indicated in a measurement object configuration of a first cell, and wherein the multiple SSBs in the SSB burst are associated with a second cell.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more. ” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories, the one or more processors individually or collectively configured to:
receive multiple synchronization signal blocks (SSBs) in an SSB burst, wherein the multiple SSBs in the SSB burst are subject to an SSB transmission constraint based at least in part on an SSB burst periodicity associated with the SSB burst; and
decode a physical broadcast channel (PBCH) using PBCH combining based at least in part on respective PBCH transmissions included in the multiple SSBs in the SSB burst.

2. The UE of claim 1, wherein the SSB transmission constraint is based at least in part on the SSB burst periodicity satisfying a periodicity threshold.

3. The UE of claim 1, wherein the SSB transmission constraint is based at least in part on the SSB burst periodicity being greater than 20 milliseconds.

4. The UE of claim 1, wherein the multiple SSBs, in accordance with the SSB transmission constraint, occupy adjacent SSB positions in the SSB burst.

5. The UE of claim 1, wherein the SSB burst includes M SSBs, wherein M is greater than one, and wherein the M SSBs, in accordance with the SSB transmission constraint, occupy M adjacent SSB positions starting at a first SSB position in the SSB burst.

6. The UE of claim 1, wherein the multiple SSBs, in accordance with the SSB transmission constraint, include at least a minimum number of SSBs in the SSB burst, wherein the minimum number is based at least in part on the SSB burst periodicity satisfying a periodicity threshold.

7. The UE of claim 1, wherein the multiple SSBs in the SSB burst, in accordance with the SSB transmission constraint, are associated with a same beam.

8. The UE of claim 7, wherein SSBs in the SSB burst, in accordance with the SSB transmission constraint, are associated with the same beam.

9. The UE of claim 7, wherein the multiple SSBs are included in a group of SSBs among one or more groups of SSBs included in the SSB burst, and wherein the SSBs in the group of SSBs, in accordance with the SSB transmission constraint, are associated with the same beam.

10. The UE of claim 7, wherein the one or more processors, to decode the PBCH using PBCH combining, are individually or collectively configured to:
average a PBCH channel estimation across the multiple SSBs, associated with the same beam, using demodulation reference signal (DMRS) bundling.

11. The UE of claim 1, wherein the SSB transmission constraint is associated with a dedicated set of frequency locations for reception of SSBs in a non-terrestrial network (NTN) associated with the SSB burst periodicity.

12. The UE of claim 1, wherein the one or more processors are further individually or collectively configured to:
receive, via a current serving cell, an indication of the SSB transmission constraint in system information associated with a neighbor cell, wherein the multiple SSBs in the SSB burst are associated with the neighbor cell.

13. The UE of claim 12, wherein the indication of SSB transmission constraint is included in a system information block (SIB) type 3 (SIB3) or a SIB type 4 (SIB4).

14. The UE of claim 1, wherein the one or more processors are further individually or collectively configured to:
receive an indication of the SSB transmission constraint in a measurement object configuration associated with a measurement of a neighbor cell, wherein the multiple SSBs in the SSB burst are associated with the neighbor cell.

15. The UE of claim 1, wherein the one or more processors are further individually or collectively configured to:
receive, via a current serving cell, an indication of the SSB transmission constraint in system information associated with a neighbor satellite, wherein the multiple SSBs in the SSB burst are associated with a neighbor non-terrestrial cell.

16. The UE of claim 15, wherein the indication of the SSB transmission constraint is included in a system information block (SIB) type 19 (SIB19).

17. The UE of claim 1, wherein the one or more processors are further individually or collectively configured to:
transmit, to a network node, a communication based at least in part on decoding the PBCH.

18. A network node for wireless communication, comprising:
one or more memories; and
one or more processors coupled to the one or more memories, the one or more processors individually or collectively configured to:
transmit multiple synchronization signal blocks (SSBs) in an SSB burst in accordance with an SSB burst periodicity, wherein the multiple SSBs in the SSB burst are subject to an SSB transmission constraint based at least in part on the SSB burst periodicity; and
receive, from a user equipment (UE), a communication based at least in part on at least one of the multiple SSBs in the SSB burst.

19. The network node of claim 18, wherein the SSB transmission constraint is based at least in part on the SSB burst periodicity satisfying a periodicity threshold.

20. A method of wireless communication performed by a user equipment (UE), comprising:
receiving multiple synchronization signal blocks (SSBs) in an SSB burst, wherein the multiple SSBs in the SSB burst are subject to an SSB transmission constraint based at least in part on an SSB burst periodicity associated with the SSB burst; and decoding a physical broadcast channel (PBCH) using PBCH combining based at least in part on respective PBCH transmissions included in the multiple SSBs in the SSB burst.
